(19) United States
(12) Patent Application Publication
(10) Pub. No.: US 2026/0133810 A1
(43) Pub. Date: May 14, 2026

(54) INFORMATION PROCESSING APPARATUS AND CONTROL METHOD

(71) Applicant: Lenovo (Singapore) Pte. Ltd., Singapore (SG)

(72) Inventors: Takashi Sugawara, Kanagawa (JP); Tingting Zhang, Kanagawa (JP); Yusuke Taira, Kanagawa (JP)

(73) Assignee: Lenovo (Singapore) Pte. Ltd., Singapore (SG)

(21) Appl. No.: 19/378,889

(22) Filed: Nov. 4, 2025

(30) Foreign Application Priority Data
Nov. 13, 2024 (JP) 2024-197973

(51) Int. Cl. G06F 9/448

(52) U.S. Cl. CPC G06F 9/448

(57) ABSTRACT

An information processing apparatus includes a memory drive device which stores data used in information processing, a main controller configured to execute the information processing, and a sub controller configured to operate independently of the main controller. The main controller is connected to the memory drive device through a first interface to send and receive the data used in the information processing. The sub controller is connected to the memory drive device through a second interface for managing a state of the memory drive device. The memory drive device includes a drive controller. The drive controller is capable of changing the first interface and the second interface from an active state enabled for communication to an inactive state disabled for communication.

### CROSS-REFERENCE TO RELATED APPLICATIONS

This application claims priority to Japanese Patent Application No. 2024-197973 filed on Nov. 13, 2024, the contents of which are hereby incorporated herein by reference in their entirety.

### TECHNICAL FIELD

The present invention relates to an information processing apparatus and a control method.

### BACKGROUND

In recent years, information processing apparatuses such as personal computers (PCs) each equipped with an SSD (Solid State Drive) have become widespread. Among such information processing apparatuses, there is known an information processing apparatus using a PCIe (Peripheral Component Interconnect-Express) bus for connecting the SSD (for example, see Japanese Unexamined Patent Application Publication No. 2023-032086) to speed up data transfer. Further, among such information processing apparatuses, there is an information processing apparatus in which an interface for system management such as an SMBus (System Management Bus) is connected to the SSD in addition to the PCIe bus.

However, in a conventional information processing apparatus as described above, since the SSD is controlled by using two interfaces such as the PCIe bus and the SMBus, there is a problem that power consumption increases.

### SUMMARY

One or more embodiments of the present disclosure provide an information processing apparatus and a control method capable of reducing power consumption.

One or more embodiments provide an information processing apparatus including: a memory drive device which stores data used in information processing; a main controller configured to execute the information processing, wherein the main controller is connected to the memory drive device through a first interface to send and receive the data used in the information processing; and a sub controller configured to operate independently of the main controller, wherein the sub controller is connected to the memory drive device through a second interface for managing the state of the memory drive device, wherein the memory drive device includes a drive controller capable of changing the first interface and the second interface from an active state enabled for communication to an inactive state disabled for communication, and the drive controller is configured to release the inactive state of the first interface and the inactive state of the second interface to change the first interface and the second interface from the inactive state to the active state in response to a request from the main controller or the sub controller.

The information processing apparatus according to one or more embodiments may be such that the first interface is a PCI-Express bus interface, a CLKREQ# signal line of the PCI-Express bus interface is connected among the main controller, the sub controller, and the memory drive device, and the main controller is configured to release the inactive state of the first interface and the inactive state of the second interface to change the first interface and the second interface from the inactive state to the active state in response to a request to change the CLKREQ# signal line to an effective state from the main controller or the sub controller.

The information processing apparatus according to one or more embodiments may also be such that the memory drive device includes a PLL circuit (Phase Locked Loop circuit) configured to generate, from a basic clock signal, a multiplied synchronous clock signal used to send and receive the data in the PCI-Express bus interface, the PLL circuit is stopped in the inactive state of the first interface, and in response to changing the CLKREQ# signal line to the effective state, the drive controller starts the operation of the PLL circuit to release the inactive state of the first interface.

The information processing apparatus according to one or more embodiments may further be such that the second interface is any one of an SMBus (System Management Bus) interface, an I2C bus interface, and an I3C bus interface.

Further, one or more embodiments of the present disclosure provide a control method for an information processing apparatus including: a memory drive device which stores data used in information processing; a main controller configured to execute the information processing, wherein the main controller is connected to the memory drive device through a first interface to send and receive the data used in the information processing; and a sub controller configured to operate independently of the main controller, wherein the sub controller is connected to the memory drive device through a second interface for managing the state of the memory drive device, the control method including: causing a drive controller to change the first interface and the second interface in the memory drive device from an active state enabled for communication to an inactive state disabled for communication, wherein the drive controller is included in the memory drive device; and causing the drive controller to release the inactive state of the first interface and the inactive state of the second interface to change to the active state in response to a request from the main controller or the sub controller.

Further, one or more embodiments of the present disclosure provide an information processing apparatus including: an information communication device for communicating data used in information processing; a main controller configured to execute the information processing, wherein the main controller is connected to the information communication device through a first interface to send and receive the data used in the information processing; and a sub controller configured to operate independently of the main controller, wherein the sub controller is connected to the information communication device through a second interface for managing the state of the information communication device, wherein the main controller is capable of changing the first interface and the second interface from an active state enabled for communication to an inactive state disabled for communication; and the main controller is configured to release the inactive state of the first interface and the inactive state of the second interface to change the first interface and the second interface from the inactive state to the active state in response to a request from the main controller or the sub controller.

Further, one or more embodiments of the present disclosure provide a control method for an information processing apparatus including: an information communication device for communicating data used in information processing; a main controller configured to execute the information processing, wherein the main controller is connected to the information communication device through a first interface to send and receive the data used in the information processing; and a sub controller configured to operate independently of the main controller, wherein the sub controller is connected to the information communication device through a second interface for managing the state of the information communication device, the control method including: causing the main controller to change the first interface and the second interface in the information communication device from an active state enabled for communication to an inactive state disabled for communication; and causing the main controller to release the inactive state of the first interface and the inactive state of the second interface to change the first interface and the second interface from the inactive state to the active state in response to a request from the main controller or the sub controller.

One or more embodiments of the present disclosure may reduce power consumption.

### BRIEF DESCRIPTION OF THE DRAWINGS

FIG. 1 is a diagram illustrating an example of a main hardware configuration of a laptop PC and an SSD according to one or more embodiments.

FIG. 2 is a functional block diagram illustrating an example of the functional configuration of the laptop PC and the SSD according to one or more embodiments.

FIG. 3 is a table illustrating an example of states of the SSD according to one or more embodiments.

FIG. 4 is a diagram illustrating an example of state transitions of the SSD according to one or more embodiments.

FIG. 5 is a flowchart illustrating an example of the operation of the laptop PC according to one or more embodiments

### DETAILED DESCRIPTION

An information processing apparatus and a control method according to one or more embodiments of the present disclosure will be described below with reference to the accompanying drawings.

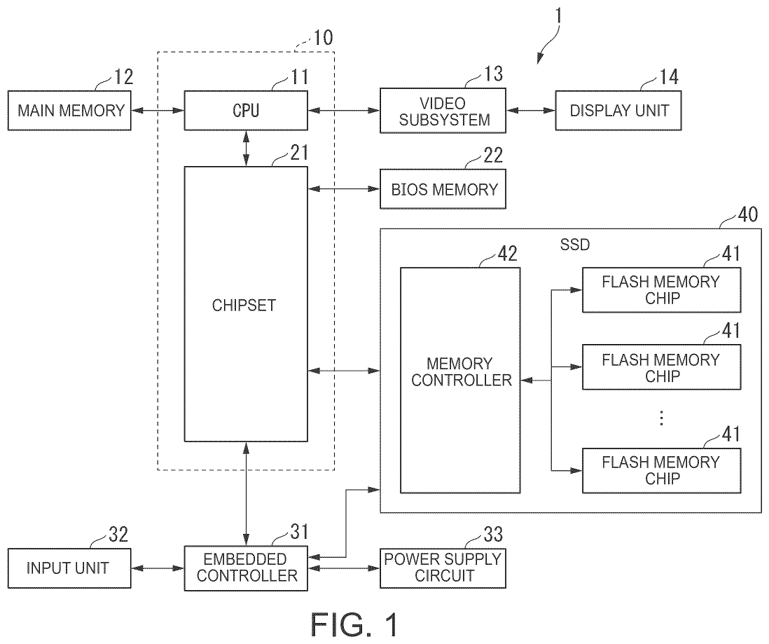

FIG. 1 is a diagram illustrating an example of the main hardware configuration of a laptop PC1 and an SSD 40 according to one or more embodiments.

As illustrated in FIG. 1, the laptop PC1 (a notebook type personal computer) includes a CPU 11, a main memory 12, a video subsystem 13, a display unit 14, a chipset 21, a BIOS memory 22, an embedded controller 31, an input unit 32, a power supply circuit 33, and the SSD 40. As an example of an information processing apparatus, a case where the information processing apparatus is the laptop PC1 will be described according to one or more embodiments.

The CPU (Central Processing Unit) 11 executes various arithmetic processes by program control and controls the entire laptop PC1.

The main memory 12 is a writable memory used as reading areas of execution programs of the CPU 11 or working areas to which processed data of the execution programs are written. The main memory 12 is composed, for example, of plural DRAM (Dynamic Random Access Memory) chips. The execution programs include an OS (Operating System), various drivers for hardware-operating peripheral devices, various services/utilities, application programs, and the like.

The video subsystem 13 is a subsystem for implementing a function related to image display, which includes a video controller. This video controller processes drawing instructions from the CPU 11, writes processed drawing information into a video memory, and reads this drawing information from the video memory to output the drawing information to the display unit 14 as drawing data (display data).

The display unit 14 is, for example, a liquid crystal display to display a display screen based on the drawing data (display data) output from the video subsystem 13.

The chipset 21 includes controllers such as USB (Universal Serial Bus), serial ATA (AT Attachment), an SPI (Serial Peripheral Interface) bus, a PCI (Peripheral Component Interconnect) bus, a PCI-Express bus (PCIe bus), and an LPC (Low Pin Count) bus, and plural devices are connected thereto. In FIG. 1, as examples of devices, the BIOS memory 22 and the SSD 40 are connected to the chipset 21.

Note that the CPU 11 and the chipset 21 correspond to a main control unit 10 (a main controller) in one or more embodiments.

The BIOS (Basic Input Output System) memory 22 is configured, for example, by an electrically rewritable non-volatile memory such as an EEPROM (Electrically Erasable Programmable Read Only Memory) or a flash ROM (flash memory). The BIOS memory 22 stores a BIOS, system firmware for controlling the embedded controller 31, and the like.

The embedded controller 31 is a one-chip microcomputer which monitors and controls various devices (peripheral devices, sensors, and the like) regardless of the system state of the laptop PC1. Further, the embedded controller 31 has a power management function to control the power supply circuit 33. Note that the embedded controller 31 is composed of a CPU, a ROM, a RAM, and the like, which are not illustrated, and includes multi-channel A/D input terminal and D/A output terminal, a timer, and digital input/output terminals. To the embedded controller 31, for example, the input unit 32, the power supply circuit 33, and the like are connected through these input/output terminals, and the embedded controller 31 controls the operation of these units.

The input unit 32 is, for example, an input unit including an input device such as a keyboard and a pointing device such as a touch pad.

The power supply circuit 33 includes, for example, a DC/DC converter, a charge/discharge unit, an AC/DC adapter, and the like to convert DC voltage, supplied, for example, from an external power supply through the AC/DC adapter or from a battery, into plural voltages required to operate the laptop PC1. Further, the power supply circuit 33 supplies power to each unit of the laptop PC1 under the control of the embedded controller 31.

The SSD (Solid State Drive) 40 is a memory drive device having rewritable non-volatile memory chips, which stores the OS, various drivers, various services/utilities, application programs, and various data. The laptop PC1 executes various information processing using data stored in the SSD 40. The SSD 40 is connected to the chipset 21, for example, through the PCI-Express bus (hereinafter, which may also be called the PCIe bus).

Note that the SSD 40 can communicate through an SMBus (System Management Bus) interface (second interface) via the embedded controller 31 in addition to a PCIe bus interface (first interface). Communication through two interfaces of the PCIe bus interface and the SMBus interface will be described later.

Further, the SSD 40 includes plural flash memory chips 41 and a memory controller 42.

Each of the flash memory chips 41 is, for example, a NAND flash memory chip. For example, the flash memory chip 41 includes floating-gate memory cells, or charge-trap memory cells to store data by trapping electrons in a charge trap layer without including any floating gate.

The memory controller 42 is, for example, a processor including a CPU, a ROM, a RAM, and the like, which are not illustrated, to control the SSD 40 comprehensively. For example, the memory controller 42 executes processing such as host interface (host I/F) control processing between the chipset 21 and the embedded controller 31, memory interface (memory I/F) control processing between the flash memory chips 41, and data management processing of the flash memory chips 41.

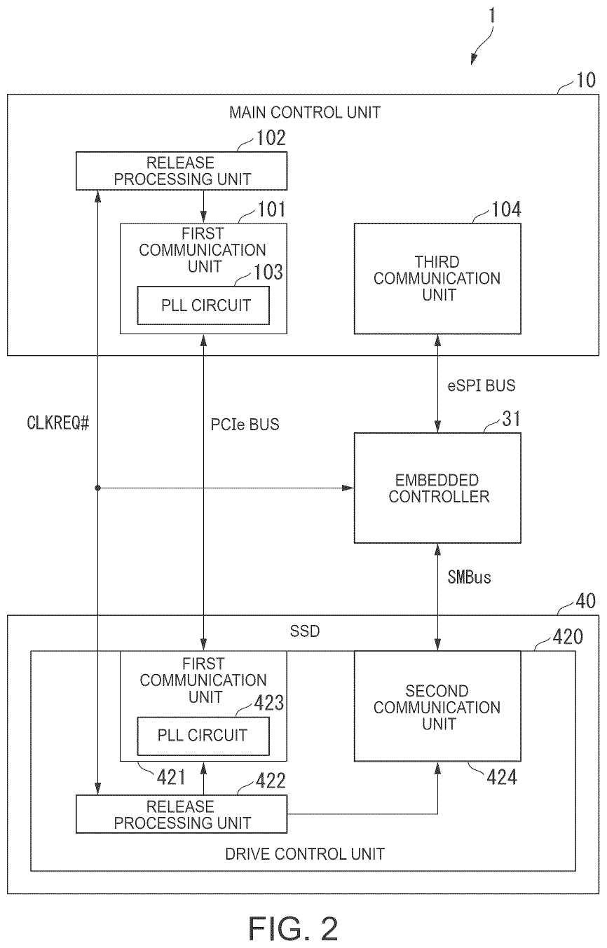

Referring next to FIG. 2, the functional configuration of the laptop PC1 according to one or more embodiments will be described.

FIG. 2 is a functional block diagram illustrating an example of the functional configuration of the laptop PC1 according to one or more embodiments.

As illustrated in FIG. 2, the laptop PC1 includes the main control unit 10, the embedded controller 31, and the SSD 40.

Note that the main control unit 10 and the SSD 40 are connected through two interfaces of the PCIe bus interface (first interface) and the SMBus interface (second interface) via the embedded controller 31.

The main control unit 10 is a functional unit, implemented by the CPU 11 and the chipset 21 executing programs stored in the main memory 12, to execute various processing (information processing) based on the OS. For example, the main control unit 10 executes various processing based on data stored in the SSD 40 and management processing for managing the SSD 40. The main control unit 10 includes a first communication unit 101, a release processing unit 102, a PLL circuit 103, and a third communication unit 104.

The first communication unit 101 is a functional unit implemented, for example, by using a PCIe bus interface device (not illustrated) of the chipset 21 to carry out communication with the SSD 40 through the PCIe bus. The first communication unit 101 sends and receives data used in information processing executed by the main control unit 10.

When the first communication unit 101 is in an inactive state in which the operation of the first communication unit 101 is stopped (operation stopped state), the release processing unit 102 releases the inactive state (operation stopped state) of the first communication unit 101 in response to an activation request (startup request) through a CLKREQ# signal line of the PCIe bus to change the first communication unit 101 to an active state (operating state) enabled for communication.

In response to the activation request (startup request) through the CLKREQ# signal line, the release processing unit 102 makes the PLL circuit 103 to be described below into the operating state and changes the first communication unit 101 to the active state (operating state) enabled for communication.

The PLL circuit 103 (Phase Locked Loop circuit) generates a clock signal (for example, a multiplied synchronous clock signal) for the first communication unit 101 to perform data communication through the PCIe bus interface.

The third communication unit 104 is a functional unit implemented, for example, by using an eSPI (Enhanced Serial Peripheral Interface) bus interface device (not illustrated) of the chipset 21 to communicate with the embedded controller 31 through the eSPI bus. The third communication unit 104 sends and receives data for various device management and system management using the embedded controller 31.

The embedded controller 31 (an example of a sub control unit or a sub controller) operates independently of the main control unit 10, which is connected to the SSD 40 through the SMBus interface for managing the state of the SSD 40. The embedded controller 31 communicates with the main control unit 10 through the eSPI bus interface, and communicates with the SSD 40 through the SMBus interface.

Note that, when the CLKREQ# signal line is connected to the embedded controller 31, and the SMBus interface (a second communication unit 424 to be described later) of the SSD 40 is in the inactive state (operation stopped state), the SMBus interface of the SSD 40 can be changed to the active state (operating state) by changing the CLKREQ# signal line to an asserted state (effective state). Note that changing the CLKREQ# signal line to the asserted state (effective state) corresponds to a request of the main control unit 10 or the embedded controller 31 (a request for releasing the inactive state).

Further, the CLKREQ# signal line of the PCIe bus interface is connected among the main control unit 10, the embedded controller 31, and the SSD 40.

The CLKREQ# signal line is one signal line connected to three points of the main control unit 10, the embedded controller 31, and the SSD 40, and to which a pull-up resistor (not illustrated) is connected. When the main control unit 10, the embedded controller 31, and the SSD 40 are all in a released state, a High state of the CLKREQ# signal line is maintained by the pull-up resistor.

When a Low state is output as the asserted state (effective state) from any one of the main control unit 10, the embedded controller 31, and the SSD 40, the CLKREQ# signal line releases the PCIe bus interface and the SMBus interface of the SSD 40 from the inactive state (stopped state).

The SSD 40 includes a drive control unit 420 (a drive controller).

The drive control unit 420 is a functional unit implemented by the memory controller 42 to be able to change the PCIe bus interface and the SMBus interface from the active state enabled for communication to the inactive state disabled for communication.

The drive control unit 420 includes a first communication unit 421, a release processing unit 422, a PLL circuit 423, and a second communication unit 424.

The first communication unit 421 is a functional unit implemented by using a PCIe bus interface device (not illustrated) of the memory controller 42, which performs communication between the SSD 40 and the main control unit 10 through the PCIe bus. The first communication unit 421 can make a transition to a power down state, in which power consumption is reduced, by making the first communication unit 421 into the inactive state. Further, when the first communication unit 421 is in the inactive state, the inactive state of the first communication unit 421 is released through the release processing unit 422 to be able to make a transition to the active state.

In response to a request of the main control unit 10 or the embedded controller 31 (for example, the activation request (startup request)), the release processing unit 422 releases the inactive state (operation stopped state) of the PCIe bus interface and the inactive state (operation stopped state) of the SMBus interface to change to the active state (operating state). In response to a request to change the effective state (for example, the Low state) of the CLKREQ# signal line from the main control unit 10 or the embedded controller 31, the release processing unit 422 releases the inactive state of the PCIe bus interface and the inactive state of the SMBus interface to change to the active state.

In other words, the release processing unit 422 detects that the CLKREQ# signal line becomes the Low state, and when the CLKREQ# signal line becomes the Low state, the release processing unit 422 changes the first communication unit 421, the PLL circuit 423, and the second communication unit 424 to the active state.

For example, in response to the change in the CLKREQ# signal line to the effective state (the change to the Low state), the release processing unit 422 starts the operation of the PLL circuit 423 to release the inactive state of the PCIe bus interface.

The PLL circuit 423 generates a clock signal (for example, a multiplied synchronous clock signal) for the first communication unit 421 to perform data communication through the PCIe bus interface. The multiplied synchronous clock signal used for sending and receiving data in the PCI-Express bus interface is generated from a basic clock signal.

Further, when making the PCIe bus interface (the first communication unit 421) into the inactive state, the PLL circuit 423 can stop operating. The PLL circuit 423 can significantly reduce the power consumption of the SSD 40 by stopping the generation of the multiplied synchronous clock signal. While reducing power consumption, the PLL circuit 423 can make a transition from the stopped state to the operating state through the release processing unit 422.

Note that the configuration example in which the PLL circuit 423 is included in the first communication unit 421 is described in one or more embodiments, but the drive control unit 420 may also be configured to include the PLL circuit 423 outside of the first communication unit 421.

Alternatively, when sending data from the SSD 40 to the main control unit 10 via the PCIe bus interface in one or more embodiments, the data may be sent synchronously with a clock signal generated by the PLL circuit 103 of the main control unit 10 without having the PLL circuit 423.

The second communication unit 424 is a functional unit implemented by using an SMBus interface device (not illustrated) of the memory controller 42 to carry out communication between the SSD 40 and the embedded controller 31 through the SMBus. The second communication unit 424 can make a transition to a power down state, in which power consumption is reduced, by making the second communication unit 424 into the inactive state. Further, in the case of the inactive state, the inactive state of the second communication unit 424 is released through the release processing unit 422 to be able to make the transition to the active state.

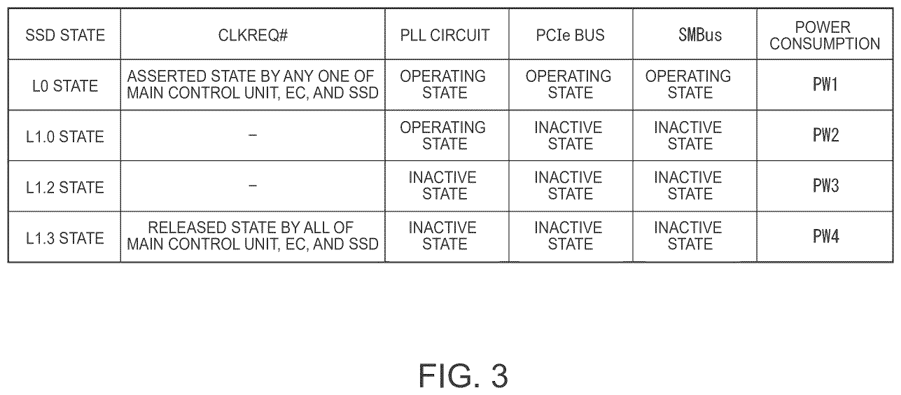

Referring next to FIG. 3, states of the SSD 40 will be described in accordance with one or more embodiments.

FIG. 3 is a table illustrating an example of states of the SSD 40 in accordance with one or more embodiments.

As illustrated in FIG. 3, the SSD 40 can be changed to L0 state, L1.0 state, L1.2 state, and L1.3 state.

The L0 state is a normal operating state in which communication is possible through both the PCIe bus and the SMBus. In the L0 state, the CLKREQ# signal line is put in the asserted state (Low state) by at least any one of the main control unit 10, the embedded controller 31, and the SSD 40.

Further, in the L0 state, the PLL circuit 423, the PCIe bus, and the SMBus are all in the operating state. In other words, in the L0 state, the PLL circuit 423, the first communication unit 421, and the second communication unit 424 are all in the operating state (active state).

Note that the power consumption of the SSD 40 in the L0 state is PW1, which is, for example, approximately several hundred mW (milliwatts).

Further, the L1.0 state is a state in which the PCIe bus is put in the inactive state (stopped state) among the PLL circuit 423, the PCIe bus, and the SMBus. In other words, in the L1.0 state, the PLL circuit 423 and the second communication unit 424 are in the operating state (active state), and the first communication unit 421 is in the inactive state (stopped state).

Note that the power consumption of the SSD 40 in the L1.0 state is PW2, which is a value smaller than the power consumption PW1 in the L0 state described above (PW1>PW2).

Further, the L1.2 state is a state in which the PLL circuit 423 and the PCIe bus are put in the inactive state (stopped state) among the PLL circuit 423, the PCIe bus, and the SMBus. In other words, in the L1.2 state, the second communication unit 424 is in the operating state (active state), and the PLL circuit 423 and the first communication unit 421 are in the inactive state (stopped state).

Note that the power consumption of the SSD 40 in the L1.2 state is PW3, which is a value smaller than the power consumption PW2 described above (PW2>PW3).

Further, the L1.3 state is a state in which the PLL circuit 423, the PCIe bus, and the SMBus are all put in the inactive state (stopped state). In other words, in the L1.3 state, the PLL circuit 423, the first communication unit 421, and the second communication unit 424 are all in the inactive state (stopped state). In the L1.3 state, the CLKREQ# signal line is put in a released state (a High state by the pull-up resistor in a disconnected state) by all of the main control unit 10, the embedded controller 31, and the SSD 40.

Note that the power consumption of the SSD 40 in the L1.3 state is PW4, which is a value smaller than the power consumption PW3 in the L1.2 state described above (PW3>PW4). The power consumption PW4 of the SSD 40 in the L1.3 state is, for example, a few mW.

Next, the operation of the laptop PC1 according to one or more embodiments will be described with reference to the accompanying drawings.

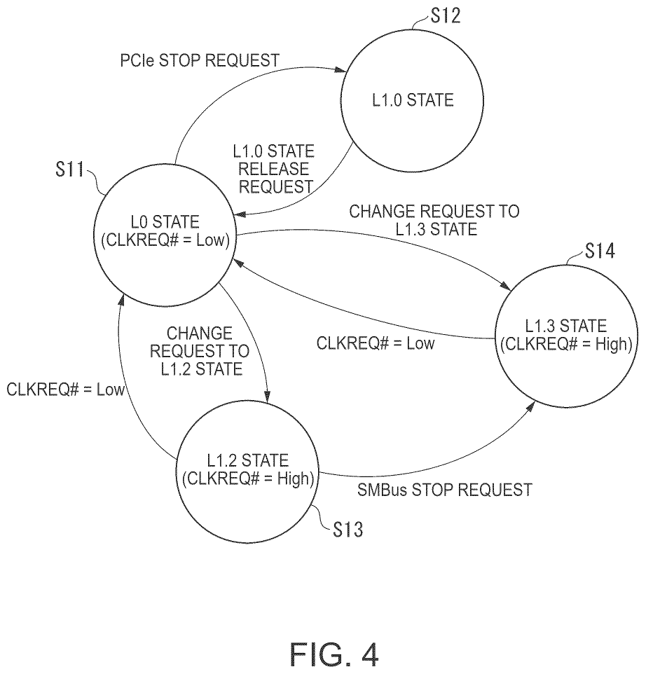

Referring first to FIG. 4, state transitions of the SSD 40 will be described in accordance with one or more embodiments.

FIG. 4 is a diagram illustrating an example of state transitions of the SSD 40 in one or more embodiments.

As illustrated in FIG. 4, State S11 is the L0 state described above. For example, when receiving a request to stop the PCIe bus from the main control unit 10, the drive control unit 420 of the SSD 40 makes a transition to the L1.0 state of State S12.

Further, in the L1.0 state of State S12, when receiving a request to release the L1.0 state, the drive control unit 420 makes a transition to the L0 state of State S11. Here, the L1.0 state release request is, for example, a request to change the CLKREQ# signal line to the asserted state from the main control unit 10, a request to release the L1.0 state from the embedded controller 31 using the SMBus, or the like.

Further, in the L0 state of State S11, when receiving a change request to the L1.2 state, the drive control unit 420 makes a transition to the L1.2 state of State S13. Here, the change request to the L1.2 state is, for example, a change request to the L1.2 state from the main control unit 10 using the PCIe bus, a change request to the L1.2 state from the embedded controller 31 using the SMBus, or the like.

Further, in the L1.2 state of State S13, for example, when receiving the Low state of the CLKREQ# signal line from the main control unit 10, the drive control unit 420 makes a transition to the L0 state of State S11.

Further, in the L1.2 state of State S13, when receiving an SMBus stop request, the drive control unit 420 makes a transition to the L1.3 state of State S14. Here, the SMBus stop request is, for example, an SMBus stop request from the embedded controller 31 using the SMBus, or the like.

Further, in the L0 state of State S11, when receiving a change request to the L1.3 state, the drive control unit 420 makes a transition to the L1.3 state of State S14. Here, the change request to the L1.3 state is, for example, a change request to the L1.3 state from the main control unit 10 using the PCIe bus, a change request to the L1.3 state from the embedded controller 31 using the SMBus, or the like.

Further, in the L1.3 state of State S14, for example, when receiving the Low state of the CLKREQ# signal line from the main control unit 10 or the embedded controller 31, the drive control unit 420 makes a transition to the L0 state of State S11.

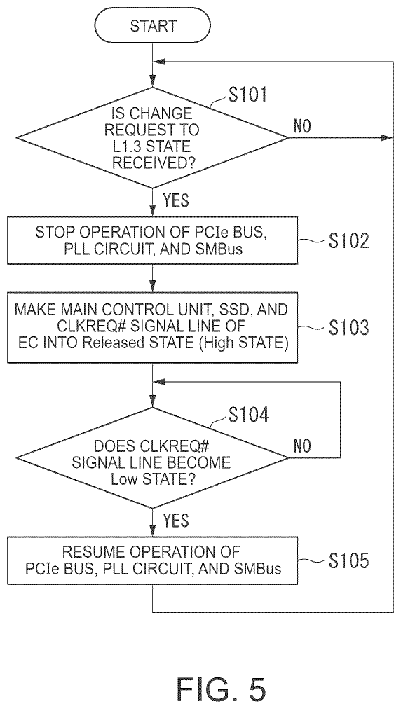

Referring next to FIG. 5, operation related to the SSD 40 of the laptop PC1 according to one or more embodiments will be described.

FIG. 5 is a flowchart illustrating an example of the operation of the laptop PC1 according to one or more embodiments. Here, it is assumed that the initial state of the SSD 40 is the L0 state described above.

As illustrated in FIG. 5, the SSD 40 of the laptop PC1 determines whether or not the change request to the L1.3 state is received (step S101). In the L0 state, the drive control unit 420 of the SSD 40 determines whether or not the change request to the L1.3 state is received through the first communication unit 421 or the second communication unit 424. When the change request to the L1.3 state is received (step S101: YES), the drive control unit 420 advances the processing to step S102. On the other hand, when the change request to the L1.3 state is not received (step S101: NO), the drive control unit 420 returns the processing to step S101.

In step S102, the drive control unit 420 stops the operation of the PCIe bus, the PLL circuit 423, and the SMBus. In other words, the drive control unit 420 stops the operation of all of the PLL circuit 423, the first communication unit 421, and the second communication unit 424, and makes the transition to the L1.3 state.

Next, the laptop PC1 makes the main control unit 10, the SSD 40, and the CLKREQ# signal line of the embedded controller 31 (EC) into the released state (that is, the High state) (step S103).

Next, the drive control unit 420 determines whether or not the CLKREQ# signal line becomes the Low state (step S104). In other words, the release processing unit 422 of the drive control unit 420 determines whether or not the CLKREQ# signal line becomes the Low state. When the CLKREQ# signal line becomes the Low state (step S104: YES), the release processing unit 422 advances the processing to step S105. On the other hand, when the CLKREQ# signal line does not become the Low state (step S104: NO), the release processing unit 422 returns the processing to step S104.

In step S105, the release processing unit 422 resumes the operation of the PCIe bus, the PLL circuit 423, and the SMBus. In other words, the release processing unit 422 resumes the operation of the PLL circuit 423, the first communication unit 421, and the second communication unit 424, and releases the L1.3 state to make the transition to the L0 state. After the process in step S105, the drive control unit 420 returns the processing to step S101.

As described above, the laptop PC1 (information processing apparatus) according to one or more embodiments includes the SSD 40 (memory drive device), the main control unit 10, and the embedded controller 31 (sub control unit), wherein the SSD 40 stores data used in information processing. The main control unit 10 executes the information processing, which is connected to the SSD 40 through the PCI-Express bus interface (first interface) to send and receive the data used in the information processing. The embedded controller 31 operates independently of the main control unit 10, which is connected to the SSD 40 through the SMBus interface (second interface) for managing the state of the SSD 40. The SSD 40 includes the drive control unit 420, and the drive control unit 420 includes the release processing unit 422. The drive control unit 420 can change the PCIe bus interface and the SMBus interface from the active state enabled for communication to the inactive state disabled for communication. In response to a request (inactive state release request) of the main control unit 10 or the embedded controller 31, the release processing unit 422 releases the inactive state of the PCIe bus interface and the inactive state of the SMBus interface to change to the active state.

Thus, the laptop PC1 (information processing apparatus) according to one or more embodiments can reduce the power consumption of the SSD 40 to PW4 (approximately a few mW) by making the PCIe bus interface and the SMBus interface of the SSD 40 into a state (L1.3 state) of being changed to the inactive state. Further, the laptop PC1 (information processing apparatus) according to one or more embodiments is such that the state (L1.3 state), in which the PCIe bus interface and the SMBus interface of the SSD 40 are changed to the inactive state, can be released by the release processing unit 422 properly from either one of the main control unit 10 and the embedded controller 31. Therefore, the laptop PC1 (information processing apparatus) according to one or more embodiments may reduce power consumption.

Further, in one or more embodiments, the PCIe bus interface is a PCI-Express (PCIe) bus interface. The CLKREQ# signal line of the PCI-Express bus interface is connected among the main control unit 10, the embedded controller 31, and the SSD 40. In response to a request to change the CLKREQ# signal line to the effective state from the main control unit 10 or the embedded controller 31, the release processing unit 422 releases the inactive state of the PCIe bus interface and the inactive state of the SMBus interface to change to the active state.

Thus, the laptop PC1 according to one or more embodiments can release the state (L1.3 state), in which the PCIe bus interface and the SMBus interface of the SSD 40 are changed to the inactive state, with a simple configuration using the CLKREQ# signal line of the PCI-Express(PCIe) bus interface more easily.

Further, in one or more embodiments, the SSD 40 includes the PLL circuit 423 to generate, from a basic clock signal, a multiplied synchronous clock signal used to send and receive data in the PCI-Express bus interface. In the inactive state of the PCIe bus interface, the PLL circuit 423 is stopped. In response to changing the CLKREQ# signal line to the effective state (asserted state; Low state), the release processing unit 422 starts the operation of the PLL circuit 423 to release the inactive state of the PCIe bus interface.

Thus, the laptop PC1 according to one or more embodiments can further reduce power consumption by stopping the operation of the PLL circuit 423. Further, the laptop PC1 according to one or more embodiments can release the L1.3 state (low power-consumption state) described above properly by unsuspending the PLL circuit 423 using the CLKREQ# signal line to make it operate again.

Further, in one or more embodiments, the second interface described above is any one of the SMBus interface, an I2C bus interface, and an I3C bus interface.

Thus, since any other second interface rather than the SMBus interface, such as the I2C bus interface or the I3C bus interface, also has the same effect, the laptop PC1 according to one or more embodiments can reduce the power consumption of the laptop PC1.

Further, a control method according to one or more embodiments is a control method for the laptop PC1 (information processing apparatus) including: the SSD 40 for storing data used in information processing; the main control unit 10 for executing the information processing, which is connected to the SSD 40 through the PCIe bus interface for sending and receiving the data used in the information processing; and the embedded controller 31 to operate independently of the main control unit 10, which is connected to the SSD 40 through the SMBus interface for managing the state of the SSD 40, the control method including a first step and a second step. In the first step, the drive control unit 420 changes the PCIe bus interface and the SMBus interface in the SSD 40 from the active state enabled for communication to the inactive state disabled for communication. In the second step, in response to a request of the main control unit 10 or the embedded controller 31, the release processing unit 422 releases the inactive state of the PCIe bus interface and the inactive state of the SMBus interface to change to the active state.

Thus, since the control method according to one or more embodiments has the same effect as the laptop PC1 described above, the power consumption of the SSD 40 can be reduced to PW4 (approximately a few mW) by making the PCIe bus interface and the SMBus interface of the SSD 40 into a state (L1.3 state) of being changed to the inactive state, and the L1.3 state can be released properly. Therefore, the control method according to one or more embodiments may reduce the power consumption of the laptop PC1.

Note that the present disclosure is not limited to the aforementioned embodiments, and the aforementioned embodiments can be changed without departing from the scope of the present disclosure.

For example, in one or more embodiments the example in which the information processing apparatus is the laptop PC1 (notebook type personal computer) is described, but the information processing apparatus is not limited to this example, and may also be any other information processing apparatus such as a desktop personal computer or a tablet terminal.

Further, in one or more embodiments the example in which the release processing unit 422 releases the inactive state of the PCIe bus interface and the inactive state of the SMBus interface according to the asserted state (Low state) of the CLKREQ# signal line is described, but the present disclosure is not limited to this example, and the inactive state may also be released by any other method.

Further, in one or more embodiments, the example in which the first interface is the PCIe bus interface and the second interface is the SMBus interface is described, but the present disclosure is not limited to this example, and the first interface and the second interface may also be other interfaces.

Further, in one ore more embodiments, an information communication device having the first communication unit and the second communication unit (for example, the PCIe bus interface and the SMBus interface) such as a WAN device (Wide Area Network device) or a LAN device (Local Area Network device) may replace the SSD 40. In other words, the present disclosure may also be applied to an information communication device for communicating data used in information processing instead of the memory drive device (SSD 40).

Note that the configuration including the laptop PC1 and the SSD 40 described above has a computer system therein. Then, a program for implementing the function of each component included in the laptop PC1 and the SSD 40 described above may be recorded on a computer-readable recording medium so that the program recorded on this recording medium is read into the computer system and executed to perform processing in each component included in the laptop PC1 and the SSD 40 described above. Here, the fact that “the program recorded on the recording medium is read into the computer system and executed” includes installing the program on the computer system. It is assumed that the “computer system” here includes the OS and hardware such as peripheral devices and the like.

Further, the “computer system” according to one or more embodiments may also include two or more computers connected through networks including the Internet, WAN, LAN, and a communication line such as a dedicated line. Further, the “computer-readable recording medium” according to one or more embodiments means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program may be included as the recording medium. Note that the program may be split into plural pieces, downloaded at different timings, respectively, and then united in each component included in the laptop PC1 and the SSD 40, or delivery servers for delivering respective split pieces of the program may be different from one another. Further, it is assumed that the “computer-readable recording medium” may include a medium on which the program is held for a given length of time, such as a volatile memory (RAM) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions described above may be realized as an integrated circuit such as LSI (Large Scale Integration). Each function described above may be implemented by a processor individually, or some or all of the functions may be integrated as a processor. Further, the method of circuit integration is not limited to LSI, and may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

1 laptop PC
10 main control unit
11 CPU
12 main memory
13 video subsystem
14 display unit
21 chipset
22 BIOS memory
31 embedded controller (EC)
32 input unit
33 power supply circuit
40 SSD
41 flash memory chip
42 memory controller
101, 421 first communication unit
102, 422 release processing unit
103, 423 PLL circuit
104 third communication unit
424 second communication unit

What is claimed is:

1. An information processing apparatus comprising:
a memory drive device which stores data used in information processing;
a main controller configured to execute the information processing, wherein the main controller is connected to the memory drive device through a first interface to send and receive the data used in the information processing; and
a sub controller configured to operate independently of the main controller, wherein the sub controller is connected to the memory drive device through a second interface for managing a state of the memory drive device, wherein
the memory drive device includes a drive controller capable of changing the first interface and the second interface from an active state enabled for communication to an inactive state disabled for communication, and
the drive controller is configured to release the inactive state of the first interface and the inactive state of the second interface to change the first interface and the second interface from the inactive state to the active state in response to a request from the main controller or the sub controller.

2. The information processing apparatus according to claim 1, wherein
the first interface is a PCI-Express bus interface,
a CLKREQ# signal line of the PCI-Express bus interface is connected among the main controller, the sub controller, and the memory drive device, and
the main controller is further configured to release the inactive state of the first interface and the inactive state of the second interface to change the first interface and the second interface from the inactive state to the active state in response to a request to change the CLKREQ# signal line to an effective state from the main controller or the sub controller.

3. The information processing apparatus according to claim 2, wherein
the memory drive device includes a PLL circuit (Phase Locked Loop circuit) configured to generate, from a basic clock signal, a multiplied synchronous clock signal used to send and receive the data in the PCI-Express bus interface,
the PLL circuit is stopped in the inactive state of the first interface, and
in response to changing the CLKREQ# signal line to the effective state, the drive controller starts operation of the PLL circuit to release the inactive state of the first interface.

4. The information processing apparatus according to claim 1, wherein the second interface is any one of an SMBus (System Management Bus) interface, an I2C bus interface, and an I3C bus interface.

5. A control method for an information processing apparatus including: a memory drive device which stores data used in information processing; a main controller configured to execute the information processing, wherein the main controller is connected to the memory drive device through a first interface to send and receive the data used in the information processing; and a sub controller configured to operate independently of the main controller, wherein the sub controller is connected to the memory drive device through a second interface for managing a state of the memory drive device, the control method comprising:
causing a drive controller to change the first interface and the second interface in the memory drive device from an active state enabled for communication to an inactive state disabled for communication, wherein the drive controller is included in the memory drive device; and
causing the drive controller to release the inactive state of the first interface and the inactive state of the second interface to change the first interface and the second interface from the inactive state to the active state in response to a request from the main controller or the sub controller.

6. An information processing apparatus comprising:
an information communication device for communicating data used in information processing;
a main controller configured to execute the information processing, wherein the main controller is connected to the information communication device through a first interface to send and receive the data used in the information processing; and
a sub controller configured to operate independently of the main controller, wherein the sub controller is connected to the information communication device through a second interface for managing a state of the information communication device, wherein
the main controller is capable of changing the first interface and the second interface from an active state enabled for communication to an inactive state disabled for communication; and
the main controller is configured to release the inactive state of the first interface and the inactive state of the second interface to change the first interface and the second interface from the inactive state to the active state in response to a request from the main controller or the sub controller.

7. A control method for an information processing apparatus including: an information communication device for communicating data used in information processing; a main controller configured to execute the information processing, wherein the main controller is connected to the information communication device through a first interface to send and receive the data used in the information processing; and a sub controller configured to operate independently of the main controller, wherein the sub controller is connected to the information communication device through a second interface for managing a state of the information communication device, the control method comprising:
causing the main controller to change the first interface and the second interface in the information communication device from an active state enabled for communication to an inactive state disabled for communication; and
causing the main controller to release the inactive state of the first interface and the inactive state of the second interface to change the first interface and the second interface from the inactive state to the active state in response to a request from the main controller or the sub controller.
